(19) United States
(12) Patent Application Publication
(10) Pub. No.: US 2006/0290941 A1
(43) Pub. Date: Dec. 28, 2006

(54) POLARIZATION CONTROL FOR QUANTUM KEY DISTRIBUTION SYSTEMS

(75) Inventors: Morris P. Kesler, Bedford, MA (US); Katherine L. Hall, Westford, MA (US)

Correspondence Address: RAUSCHENBACH PATENT LAW GROUP, LLC, P.O. BOX 387, BEDFORD, MA, 01730, US

(73) Assignee: Wide Net Technologies, Acton, MA (US)

(21) Appl. No.: 11/164,841

(22) Filed: Dec. 7, 2005

Related U.S. Application Data
(60) Provisional application No. 60/634,654, filed on Dec. 9, 2004.

(51) Int. Cl. G01B 9/02

(52) U.S. Cl. 356/491

(57) ABSTRACT

A quantum key distribution system includes an optical transmitter that generates a multiplexed QKD data and polarization reference signal, wherein a relative polarization of a QKD data signal component and a polarization reference signal component of the multiplexed QKD data is known. A quantum channel propagates the multiplexed QKD data and polarization reference signal. An optical receiver includes a demultiplexer that demultiplexes the multiplexed QKD data and the polarization reference signal. The optical receiver also includes a detector that detects an intensity of the demultiplexed polarization reference signal. In addition, the optical receiver includes a polarization transformer that transforms a polarization of the demultiplexed QKD data signal in response to the detected intensity so that a polarization axis of the QKD data signal is substantially the same as a polarization axis of the QKD data signal generated by the optical transmitter.

### RELATED APPLICATION SECTION

This application claims priority to U.S. Provisional Patent Application Ser. No. 60/634,654, filed Dec. 9, 2004, and entitled “Polarization Control for Quantum Key Distribution Systems”, the entire application of which is incorporated herein by reference.

### FEDERAL RESEARCH STATEMENT

This invention was made with Government support under Grant Numbers FA8750-04-C-0151 and FA8750-05-C-0213 awarded by the Air Force. The Government has certain rights in this invention.

### INTRODUCTION

The section headings used herein are for organizational purposes only and should not to be construed as limiting the subject matter described in the present application.

This invention relates to secure key exchange using quantum key distribution (QKD) systems. Quantum key distribution, or quantum cryptography, was proposed in the early 1980's by Wiesner and by Bennett and Brassard. QKD is an optical key distribution scheme based on the quantum mechanical properties of single photon transmission and reception.

### BRIEF DESCRIPTION OF DRAWINGS

The aspects of this invention may be better understood by referring to the following description in conjunction with the accompanying drawings, in which like numerals indicate like structural elements and features in various figures. The drawings are not necessarily to scale. The skilled artisan will understand that the drawings, described below, are for illustration purposes only. The drawings are not intended to limit the scope of the present teachings in any way.

FIG. 1 illustrates a high level schematic representation of a known quantum key distribution system.

FIG. 2 illustrates an example of a known phase-based QKD transmitter.

FIG. 3 illustrates an example of a known phase-based QKD receiver.

FIG. 4 illustrates an example representation of a single polarization basis.

FIG. 5 illustrates an example of a known automatic polarization controller appropriate for applications with higher power optical signals.

FIG. 6 illustrates an exemplary timing diagram of a QKD data signal and a single basis polarization reference signal that are time multiplexed.

FIG. 7 illustrates a schematic of one embodiment of a transmitter that time multiplexes the polarization reference signal with the QKD data signal.

FIG. 8 illustrates a schematic of one embodiment of a single basis receiver that optically demultiplexes the polarization control signal from the QKD data signal.

FIG. 9 illustrates a schematic of a known four-state QKD transmitter.

FIG. 10 illustrates one embodiment of a known receiver for a four-state, polarization based QKD system.

FIG. 11 illustrates an example representation of two non-orthogonal polarization basis.

FIG. 12 illustrates two approaches for time multiplexing the reference signals for each polarization basis with the QKD data signal.

FIG. 13 illustrates a schematic of one embodiment of a transmitter that time multiplexes the polarization tracking signal with the dual basis QKD data signal.

FIG. 14 illustrates a schematic of one embodiment of a dual-basis receiver that time demultiplexes the polarization reference signal from the QKD data signal in the optical domain.

FIG. 15 illustrates a schematic of a dual-basis QKD receiver according to the present invention that uses a single polarization controller.

FIG. 16 is a timing diagram that illustrates the timing and transmission for the three-way optical switch S1 that was described in connection with FIG. 15.

### DETAILED DESCRIPTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

It should be understood that the individual steps of the methods of the present invention may be performed in any order and/or simultaneously as long as the invention remains operable. Furthermore, it should be understood that the apparatus of the present invention can include any number or all of the described embodiments as long as the invention remains operable.

A quantum key distribution (QKD) system allows the secure exchange of a secret key between two remote locations. The security of the exchange is guaranteed through the quantum mechanical properties of the (ideally) single photon pulses sent from one location to the other, Transmitter (Tx or Alice) to the other, Receiver (Rx or Bob). Photons emitted by the Tx traverse the quantum channel, typically an optical fiber, a free space link, or a water link, and are received by the Rx.

In some QKD systems, the Tx sends weak (ideally single photon) optical pulses in one of two randomly selected polarization basis (either 0-90 degrees or 45-135 degrees). A logical “one” in the 0-90 degree basis may be represented by a photon polarized at 0 degrees with respect to the reference axis, whereas a logical “zero” may be represented by a photon polarized at 90 degrees, or vice versa. A similar convention is used for the 45-135 degree basis.

In other QKD systems, the key data are encoded in the photon phase (rather than polarization) and phase sensitive receivers are used. Phase sensitive detection techniques implemented in the Rx are typically polarization sensitive and require proper polarization alignment. In still other QKD systems, fewer or greater than two (2) phase or polarization basis are utilized in the quantum key exchange. One skilled in the art will appreciate that there are many equivalent implementations of QKD systems.

At the Rx, a measurement is performed in one of the polarization or phase bases, randomly selected for each pulse. In general, the Rx will contain multiple optical paths that the photon may traverse. These paths may correspond to different bases, or different polarization or phase states. As a result, a QKD receiver is said to be made up of multiple “arms” or “paths”, each of which is terminated in a photon detector. Information regarding the polarization or phase state of the photon is determined by which of the photon detectors detects a photon, that is, which arm the photon traversed. In known one-way systems, the QKD receiver is polarization sensitive, and signal polarization states are pre-aligned or are aligned manually at the input to the Rx. A QKD system of the present invention tracks the input polarization to the receiver and automatically adjusts the polarization to the correct orientation using an embedded polarization transformer and control circuit. Numerous types of polarization transforms can be used with the present invention.

Polarization controller and tracking algorithms are used to maintain proper polarization alignment of optical signals at the input to a receiver. Known optical signal control techniques, which generate an error signal for the control algorithm from the optical signal itself, are not suitable in QKD systems because the QKD data signal is so weak. In addition, dual non-orthogonal basis polarization control for QKD systems is a more demanding application than other known single basis applications, such as polarization control in coherent receivers or polarization demultiplexers and compensators. The methods and apparatus of the invention provide polarization control for QKD and other low optical signal level systems, or other communication systems, requiring alignment of a single polarization basis or multiple polarization bases.

Because the QKD data signal is so weak (ideally a single photon per signal bit), it is desirable to send a separate polarization reference signal that can be used for polarization control. In one embodiment, a polarization reference signal is time multiplexed with the QKD data signal at the transmitting terminal and optically demultiplexed at the receiving terminal.

In some embodiments, the polarization reference signal is at the same optical wavelength as the QKD data signal. Placing the reference signal at the same wavelength as the QKD data signal greatly reduces the polarization tracking impairments associated with birefringence and polarization mode dispersion in the end-to-end system. In some embodiments, the polarization reference signal also has a predetermined polarization relationship with respect to the QKD data signal to ensure that both the QKD data signal and the polarization reference signal undergo the same polarization transformation between the transmitter and receiver.

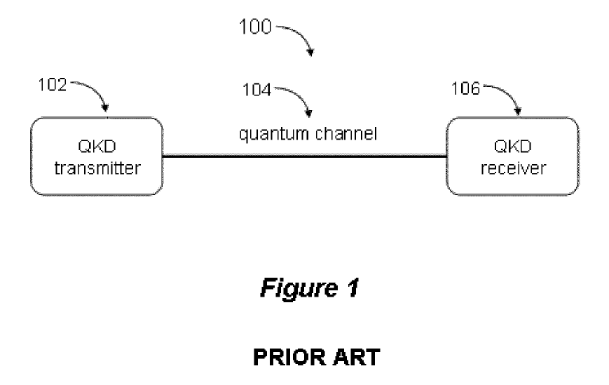

FIG. 1 illustrates a high level schematic representation of a known quantum key distribution system 100. Photons emitted by the QKD Tx 102 traverse the quantum channel 104, which can be an optical fiber, free space or water link, and are received by the QKD Rx 106. For most systems, the QKD Rx 106 requires a specific polarization alignment of the incoming signal in order to operate correctly. In general, the quantum channel 104 does not preserve the polarization state of the QKD data signal between the QKD Tx 102 and QKD Rx 106. Therefore, a polarization transformation and/or the alignment of polarization axes between the transmitting terminal and the remote receiving terminal are generally required. Depending on the particular QKD implementation (phase or polarization based), polarization alignment is required for a single polarization basis, for two non-orthogonal bases, or for more than two non-orthogonal bases.

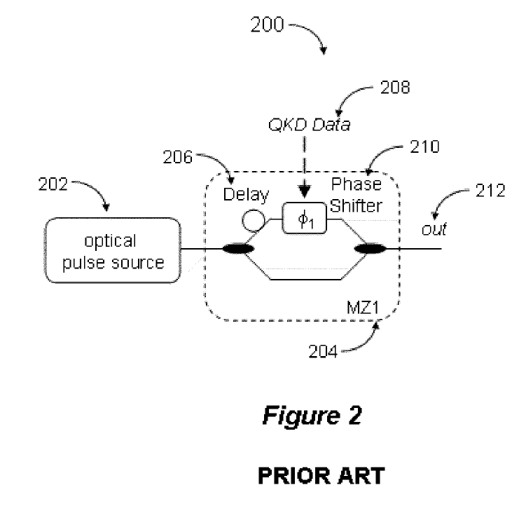

FIG. 2 illustrates an example of a known phase-based QKD transmitter 200. In this embodiment, the phase-based QKD system utilizes an optical phase shifter 210 in one arm of a long delay Mach-Zehnder interferometer 204. Present embodiments for high-speed phase shifters, such as those using an electro-optic material, require that the input signal be linearly polarized for proper operation. In this case, polarization alignment and tracking would be required for only a single polarization basis. Since the optical pulse source 202 generally provides a linearly polarized output, proper polarization alignment can be accomplished in the QKD transmitter by making the connection between the optical pulse source 202 and the phase shifter 210 polarizing or polarization maintaining.

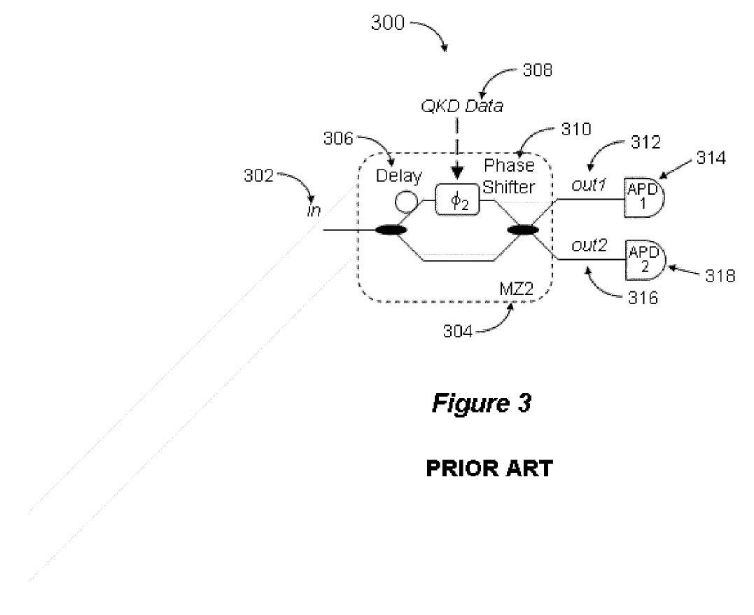

FIG. 3 illustrates an example of a phase-based QKD receiver 300. The receiver includes a Mach-Zehnder interferometer 304 with a delay 306 and phase shifter 310 in one arm. QKD data 308 is applied to the phase shifter 310. A first output 312 of the Mach-Zehnder interferometer 304 is coupled to a first photon detector 314 and a second output 316 of the Mach-Zehnder interferometer 304 is coupled to a second photon detector 31 8. In this embodiment, the input optical signal 302 should be linearly polarized along a specific axis. However, the polarization of the QKD data signal after the quantum channel is generally not linearly polarized, and may not be static, so it is desirable to properly track and transform the polarization prior to the input 302 of the QKD receiver 300.

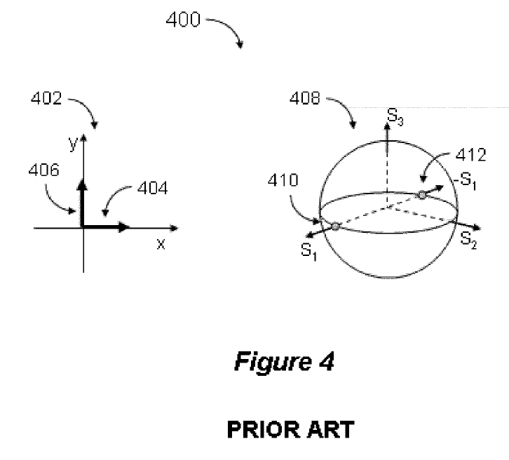

FIG. 4 illustrates an example representation of a single polarization basis. The pertinent polarizations in a single basis scheme may be represented as being on opposite sides of the Poincare sphere, 180° apart 408. For example, assume the polarization basis to be 0° and 90° (404 and 406), or ±Si (410 and 412) on the Poincare sphere 408 as illustrated. In this example, a polarizing beamsplitter (PBS) can be used to separate the two signals, and the polarization must simply be adjusted so that the signals come out the proper (pre-defined) ports of a PBS, i.e., aligned with the S₁ axis. Note that there can be an arbitrary phase between the two orthogonal polarized signal bits 404 and 406. Equivalently, the polarization transform can have an arbitrary rotation about the axis of the desired polarization (S₁ in this case) without having an effect on the amplitude of the PBS outputs.

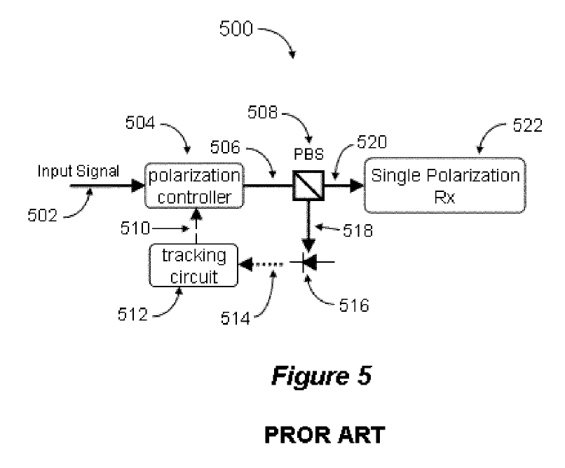

FIG. 5 illustrates an example of a known automatic polarization controller 500 appropriate for applications with higher power optical signals. In a single basis polarization tracking system with higher power optical signals, a portion of the optical data signal 502 may be tapped off 518 and monitored with the detection 516 and control electronic circuits 512. In the embodiment illustrated here, the input signal 502 travels through a polarization control device 504 and then to a PBS 508. One output port 520 of the PBS 508 connects to the single polarization receiver 522, while the other output port 518 is detected with a photodiode 516 and used for controlling the polarization.

A tracking circuit 512 adjusts the polarization control device 504 to minimize the signal power on the photodiode 516. This maximizes the signal power at the other output 520 of the PBS 508 that is connected to the single polarization receiver 522 and creates linear polarization at that point. The connection 520 between the PBS 508 and the single polarization receiver 522 should be polarizing or polarization maintaining to ensure the correct polarization to the input of the receiver 522. This type of signal power based stabilization scheme cannot be applied to QKD and other low power system applications because the data signals cannot be tapped and are too weak to be used for feedback.

In QKD applications, or other low optical signal power applications, requiring single basis polarization control, it is desirable to send a separate polarization reference signal that can be used for polarization control. This separate polarization reference signal can be distinguished from the QKD data signal in any way. For example, the polarization reference signal can be distinguished from the QKD data signal by having a separate wavelength band, a separate time slot, or a different modulation format. The polarization reference signal can have any format as long as it can be separated from the data signal with optical detection and demultiplexing techniques. For example, in one embodiment, the polarization reference signal is time multiplexed with the QKD data signal at the transmitting terminal and then optically demultiplexed at the receiving terminal.

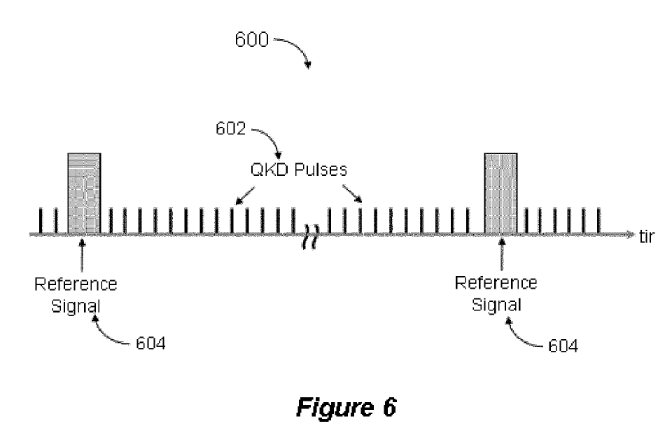

FIG. 6 illustrates an exemplary timing diagram 600 of a QKD data signal 602 and a single basis polarization reference signal 604 that are time multiplexed. The reference signal 604 is periodically located in the stream of QKD data signal 602 pulses. The time between the reference signals and the duration of the reference signals is adjustable and may be determined based on the desired polarization tracking speed. For the single basis case, the polarization reference signal 604 is polarized parallel to one axis of the QKD polarization basis in the transmitter. That is, if the QKD data signal uses the x-y basis 402 as shown in FIG. 4, the reference signal should be either parallel or orthogonal to the data signals it is time multiplexed with in the QKD transmitter. Aligning the reference signal to the x-y plane in the receiver will then align the QKD data signal to the necessary x-y basis for the receiver.

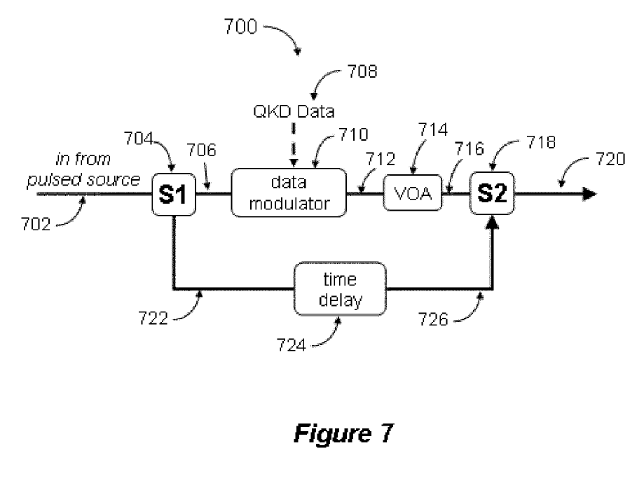

FIG. 7 illustrates a schematic of one embodiment of a transmitter 700 that time multiplexes a polarization reference signal with the QKD data signal. This transmitter is described further in U.S. Provisional Patent Application Ser. No. 60/634,653, filed Dec. 9, 2004, entitled, “Robust Serial Polarization-Encoding Transmitter for Quantum Key Distribution (QKD) Systems”. The entire specification of U.S. Provisional Patent Application, Ser. No. 60/634,653 is herein incorporated by reference.

The input signal 702 is a stream of optical pulses having a repetition rate that is the same as the repetition rate of the QKD transmitter signal. The optical switch S1 704 is used to switch the input signal 702 either into the data signal path 706 or into the reference signal path 722. The reference signal 722 goes through a time delay 724 to match the propagation delay of the QKD data signal through the data path and is then multiplexed back with the QKD data signal 716 with optical switch S2 718. In some embodiments, the optical switch S2 718 is a passive polarization maintaining coupler.

The QKD data signal 716 is created when S1 704 directs the input signal 702 into the data path where it is modulated by the data modulator 710 and then attenuated down by the variable optical attenuator (VOA) 714 to the desired level before being recombined with the polarization reference signal 726. In some phase-based embodiments, the data modulator is a Mach-Zehnder interferometer 204 as shown in FIG. 2. Polarization is maintained between the QKD 716 and the control signal 726 by using polarization maintaining fiber prior to switch S2 718, which ensures that the QKD 716 and the control signal 726 have the same or orthogonal polarization.

The switches 704, 718 must have a high enough extinction ratio to sufficiently reduce the amount of light leaking through to the polarization reference signal path 722 when the switch is configured to direct the light to the data signal path. The intensity of the light leaking through to the polarization reference signal path 722 should be much lower than the intensity of the data signal at the output of the VOA 716. In some embodiments, the extinction ratios of the switches 704, 714 are improved by cascading multiple switches, or by connecting several VOAs in series with the optical switches 704, 714. There are numerous other techniques that improve switch extinction ratios that are known in the art.

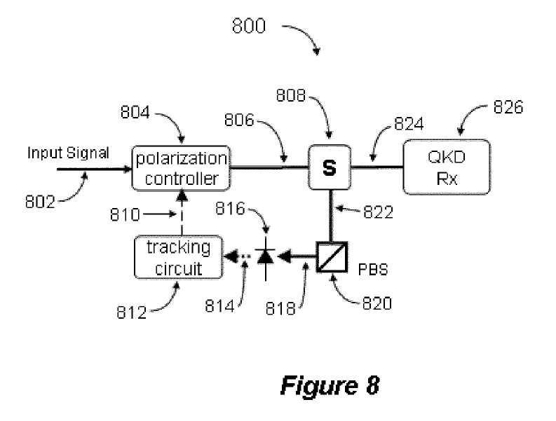

FIG. 8 illustrates a schematic of one embodiment of a single basis receiver 800 according to the present invention that time demultiplexes the polarization reference signal from the QKD data signal in the optical domain. In many embodiments, the signal transmitted across the quantum channel 802 will have an arbitrary polarization that must be transformed into the proper polarization for the QKD receiver 826.

The signal transmitted across the quantum channel 802 is a combination of the QKD data signal and the reference signal. The transmitted signal propagates through a polarization controller 804 and then through an optical switch S 808. The optical switch 808 is gated to route the polarization reference signals via a separate optical fiber 822 to the PBS 820 for polarization reference signal detection 816. A detector 816, such as a photodetector, detects the reference signal and then generates an electrical control signal in response to the detected reference signal.

A tracking circuit 812 receives the electrical control signal in response to the detected reference signal and then generates an electrical signal for controlling the polarization controller 804. The output of the tracking circuit 812 is connected to a control input of the polarization controller 804. The electrical signal generated by the tracking circuit 812 causes the polarization controller to adjust the polarization of the input signal. For example, in one embodiment, the tracking circuit 812 adjusts the polarization controller 804 to minimize the intensity of light emerging from one port of the PBS 820. In this embodiment, the polarization of both the polarization reference signal 822 and the QKD data signal 824 are linear and aligned if polarization maintaining fiber is used on the paths 822 and 824.

The switch S 808 must be controlled synchronously with the input signal 802 to properly switch the reference signal to the PBS 820 and the QKD data signal to the QKD receiver 826. This may be accomplished through the use of a timing signal, which in some embodiments, is carried on a separate optical wavelength or over a separate channel. The switch extinction ratio must be high enough to reduce the amount of polarization reference signal light leaking through to the QKD receiver 826 as described in connection with FIG. 7. In some embodiments, the switch S 808 is implemented using a cascade of optical switching and attenuating elements.

QKD systems using a four-state polarization based protocol alternate between two non-orthogonal bases from pulse to pulse (e.g. 0° and 45° basis). Data is encoded in the polarization of the single photon pulse. In one embodiment, a logical “one” in the 0° basis is represented by linear polarization at 0° with respect to the x-axis, and a logical “zero” is represented by the orthogonal linear polarization at 90° with respect to the x-axis. Similar polarization encoding is done in the 45° basis in which the linear polarizations are rotated by 45° with respect to the 0° basis. The choice of basis is made randomly from pulse-to-pulse in the transmitter.

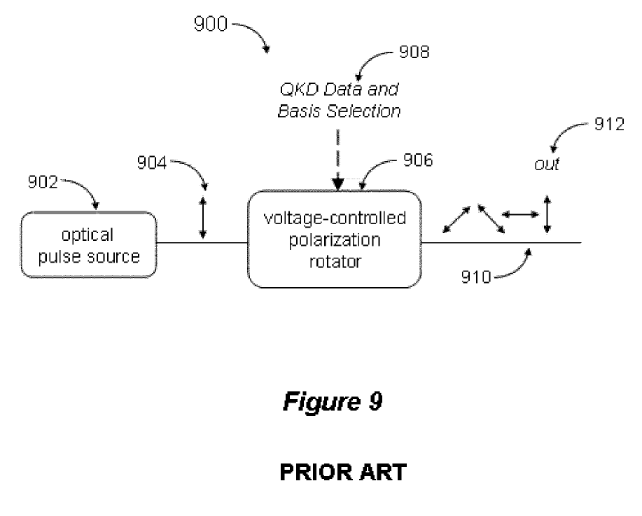

FIG. 9 illustrates a schematic of a known four-state QKD transmitter 900. An optical pulse source 902 produces linearly polarized single photon pulses 904. The polarization of the pulses 904 is rotated by a voltage-controlled polarization rotator 906, according to the random QKD data and basis selection control circuit 908. The output 912 of the voltage-controlled polarization rotator 906 is a series of single photon pulses in one of four possible linear polarization states 910.

The remote receiving terminal for this QKD system will decode the polarization encoded data by performing a simple polarization analysis of the arriving single photon pulses in one of the two possible basis, 0° or 45°. The choice of basis in the receiver is made randomly from pulse to pulse.

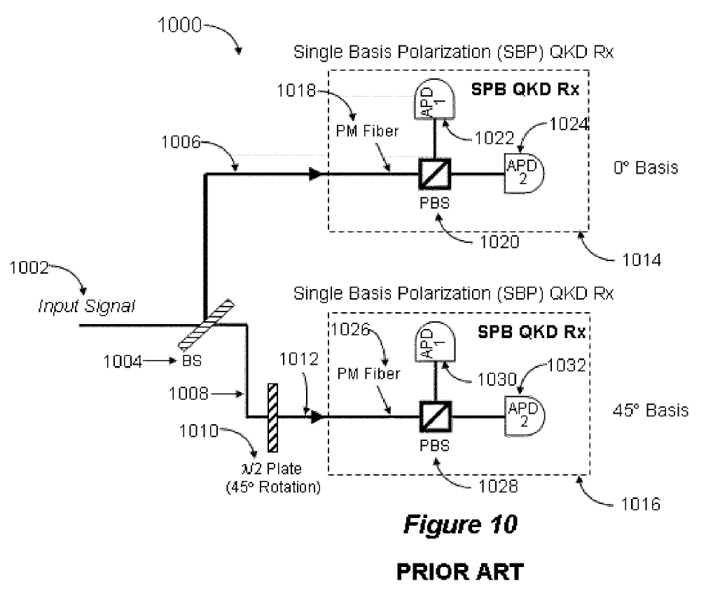

FIG. 10 illustrates one embodiment of a known receiver for a four-state, polarization based QKD system 1000. The random basis selection is accomplished by sending the input signal 1002 through a polarization insensitive 50/50 beamsplitter 1004. The beamsplitter 1004 directs the input signal photons 1002 with approximately equal probability to the polarization analyzers, 1014 and 1016. For example, the polarization analyzers 1014, 1016 can include a PBS 1020, 1028 whose output ports are connected to a first group of single photon detectors 1022, 1030 and a second group of single photon detectors 1024, 1032. The detectors 1022, 1030, 1024, and 1032 can be avalanche photodiodes or other single photon detectors. A half-wave plate 1010 rotates the polarization of the input signal to one polarization analyzer 1012 by 45°.

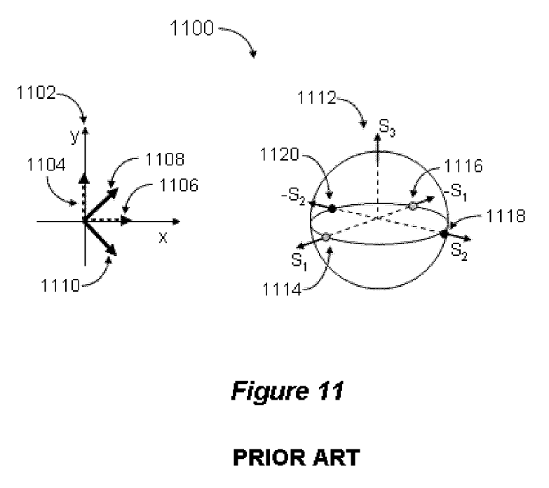

FIG. 11 illustrates an exemplary representation of two non-orthogonal polarization bases 1100. The input data signal to the QKD receiver is linearly polarized along axes defined with respect to the QKD transmitter for the operation of the four polarization system described herein. The graph 1102 illustrates the linear polarizations for data signal bits in the 0° and 45° basis. These are the desired polarizations at the input to the QKD receiver. The desired polarizations are represented on the Poincare sphere 1112 by the points ±S₁ for the 0° basis (1114 and 1116) and ±S₂ for the 45° basis (1118 and 1120).

The input signal polarization at the receiver must be adjusted so that both of the axes are properly aligned with respect to the axes of the polarization analyzer units 1014 and 1016 (FIG. 10). Unlike the single polarization basis case, there is only one polarization transform that aligns both basis correctly. That is, there is no freedom for an arbitrary rotation about any axis (with the exception of full 2 pi rotations). In other words, the polarization controller must remove the effects (modulo 2 pi) of any birefringence between the transmitter and receiver.

As with polarization control for single basis QKD systems, it is desirable to send a separate polarization reference signal that can be used for polarization control. In one embodiment of the multi-basis implementation, the polarization reference signal is time multiplexed with the QKD data signal at the transmitting terminal and then optically demultiplexed at the receiving terminal. Some embodiments of the present invention are illustrated with two non-orthogonal bases. However, one skilled in the art will appreciate that the methods of the present invention apply to systems with many other data state implementations.

The polarization reference signal used in some embodiments of the present invention contains components in both the 0° and 45° polarization basis in order to accomplish the more stringent polarization alignment needed for a dual-basis QKD system. In other embodiments, the polarization of the reference signal is temporally alternated between the two bases.

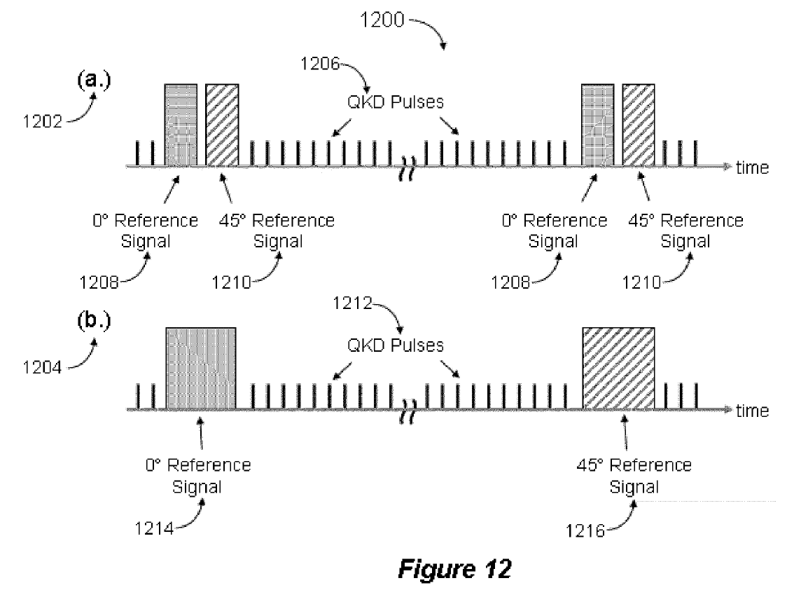

FIG. 12 illustrates two approaches for time multiplexing the reference signals for each polarization basis with the QKD data signal 1200. The first signal 1202 includes a polarization reference signal that contains components in both the 0/90° basis 1208 and the 45/135° basis 1210. The reference signal is periodically multiplexed with the QKD data signal 1206. In this case, the 0/90° reference signal 1208 and 45/135° reference signals 1210 are temporally adjacent to each other. The second signal 1204 includes a 0/90° degree reference signal 1214 and a 45/135° degree reference signal 1216 that are temporally separated. One skilled in the art will appreciate that there are numerous other arrangements of the reference signals.

Synchronization is required in the receiver to properly use the reference signal to align the two polarization bases. In one embodiment, a control algorithm is used to achieve the desired polarization alignment. The control algorithm adjusts the polarization controller for the correct alignment of the S₁ basis during the first period of time. The polarization controller then adjusts the polarization controller to correctly align the S₂ basis for a second period of time. The time between the reference signals is determined by the desired polarization tracking speed as described herein in connection with the single basis case.

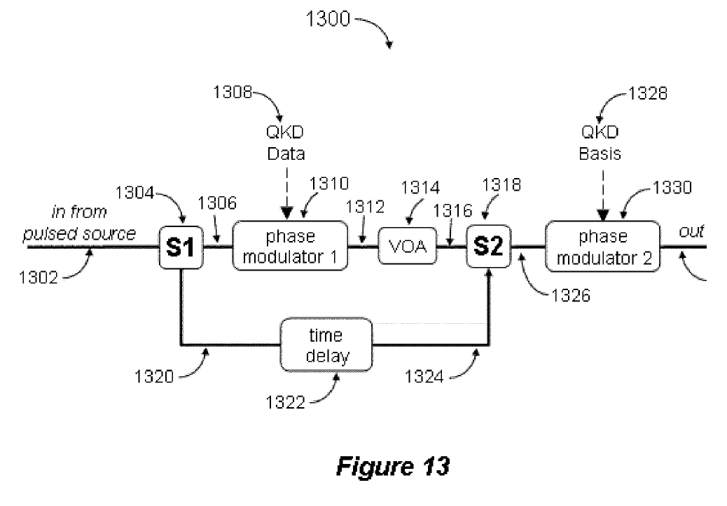

FIG. 13 illustrates a schematic of one embodiment of a transmitter that time multiplexes the polarization tracking signal with the dual basis QKD data signal 1300. This embodiment is described further in U.S. Provisional Patent Application Ser. No. 60/634,653, filed Dec. 9, 2004, entitled, “Robust Serial Polarization-Encoding Transmitter for Quantum Key Distribution (QKD) Systems”. The entire specification of U.S. Provisional Patent Application Ser. No. 60/634,653 is herein incorporated by reference.

The input signal 1302 is a stream of optical pulses having the same repetition rate as the QKD transmitter signal. The optical switch S1 1304 is used to switch the input signal 1302 into either the data signal path 1306 or into a separate reference signal path 1320. In the data path, the first phase modulator 1310 applies the QKD data 1308 to the input pulse stream using either a 0° or 90° polarization rotation depending on the value of the QKD data. A variable optical attenuator 1314 then reduces the pulse intensities to the desired level for the QKD system. The pulses that travel along the separate reference signal path 1320 are linearly polarized in the same basis as the data pulses (i.e., at 0°). These pulses are switched out of the data path so that they remain linearly polarized along one axis and so they are not attenuated to single photon levels by the VOA 1314.

The reference signal propagates through a delay line 1322 and is then time multiplexed back into the previously vacated reference signal slots of the data stream. In the embodiment shown in FIG. 13, the reference signal is switched back into the data stream by a second optical switch S2 1318. In other embodiments, a polarization maintaining passive coupler is used instead of the second optical switch S2 1318.

The reference signal pulses are then recombined with the data stream 1326. The recombined data stream 1326 propagates through the second phase modulator 1330, where some reference pulses are rotated by 45° to provide a tracking signal for the +45°/135° decoder basis. The gated nature of the drive signal 1328 to phase modulator 2 1330 enables phase modulator 2 1330 to encode basis rotations on the QKD data stream when it is not encoding the polarization reference signals.

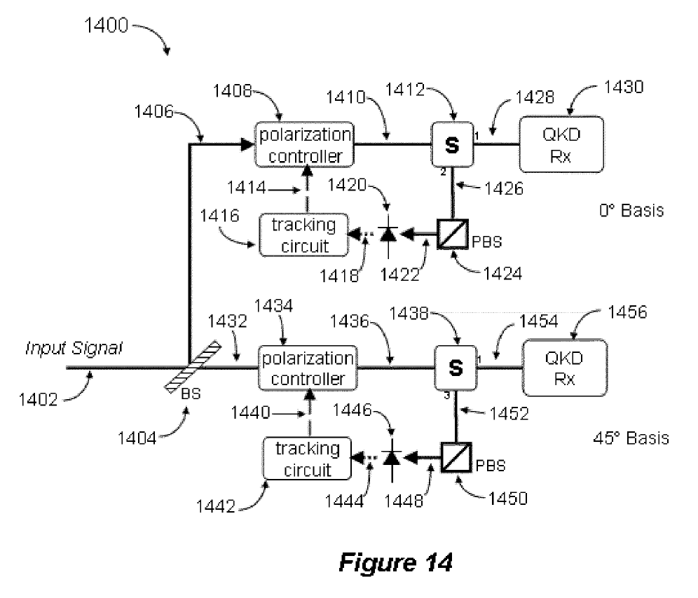

FIG. 14 illustrates a schematic of one embodiment of a dual-basis receiver that time demultiplexes the polarization reference signal from the QKD data signal 1400 in the optical domain. In general, the data/reference signal coming in from the quantum channel 1402 will be at an arbitrary polarization and must be transformed into the proper polarization for the QKD receiver. The incoming signal 1402, which comprises the QKD and the reference signals, is split by a beamsplitter (BS) 1404 into two parallel receiver paths 1406 and 1432. The QKD data signal is directed randomly to one of the two paths because it is at a single photon level.

In each path the signal goes through a polarization controller 1408 or 1434. A two-way optical switch S 1412 or 1438 is gated and used to switch the reference signal out to a PBS 1424 or 1450. In one arm, a tracking circuit 1416 selects the reference signal for the 0/90° basis (Port 2) 1426, while the other tracking circuit 1442 selects the reference signal for the 45/135° basis (Port 3) 1452. One or both outputs of the PBS 1424 or 145° is detected on at least one photodiode 1420 or 1446 and then directed to the tracking circuits 1416 or 1442 which control the polarization adjustment in each arm.

For example, the tracking circuit 1416 or 1442 may adjust the polarization controller 1408 or 1434 to minimize the intensity of light emerging from one port of the PBS 1424 or 1450. This adjustment forces the polarization of both the reference signal and the QKD data signal to be linearly aligned if a polarization maintaining connection is used on the paths 1426 and 1428. The resulting linearly polarized signal streams 1428 and 1454 in both arms are aligned with their respective QKD receiver analyzers 1430 and 1456 such that 0°/90° bits are detected accurately in the top arm 1406 of the receiver 1400, and +45°/135° bits are detected accurately in the bottom arm 1432 of the receiver 1400.

The switches S 1412 and 1438 must be controlled in synchronism with the input signal 1402 to properly switch the reference signals 1426 and 1452 to the PBSs 1424 or 1450 and the QKD data signals 1428 and 1454 to the QKD analyzers 1430 or 1456. This may be accomplished through the use of a timing signal, commonly carried on a separate optical wavelength or a separate channel.

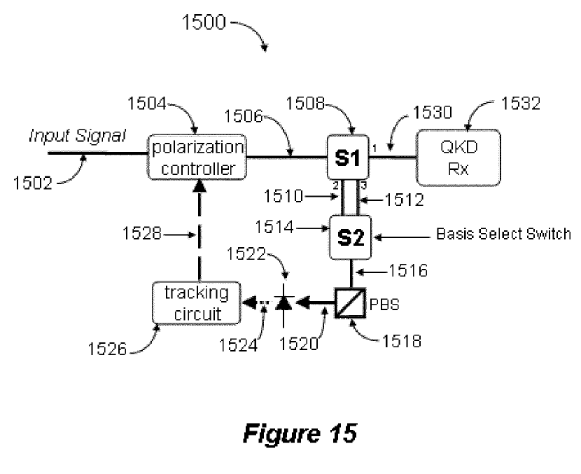

FIG. 15 illustrates a schematic of a dual-basis QKD receiver 1500 according to the present invention that uses a single polarization controller. The signal from the quantum channel consists of the QKD data and polarization reference signals 1502. This signal goes through a polarization controller or polarization rotator 1504 before reaching a three-way optical switch S1 1508. The optical switch S1 1508 directs its input to one of three output ports (1510, 1512 or 1530). During the time that the QKD data signal is present, the switch output is directed to the first Port 1530. During the time that the polarization reference signals are present, the output is directed to either the second Port 1510 (for the 0/90° basis), or to the third Port 1512 (for the 45/135° basis). For example, a three-way switch with this functionality can be constructed from numerous components, such as from a cascade of two-way switches.

Optical switch S2 1514 selects one of the tracking control signals to send to a polarization beamsplitter 1518 for polarization analysis. The switch 1514 performs the basis selection for the QKD protocol. In this embodiment, the QKD Rx 1532 requires only a single polarization analysis arm to decode the four possible input data polarization states. One or both ports of the PBS 1518 may be detected with at least one photodiode 1522 and directed to the tracking circuit 1526, which controls the polarization adjustment.

For example, the tracking circuit 1526 may adjust the polarization controller 1504 to minimize the intensity of light emerging from one port of the PBS 1518. This type of tracking forces the polarization of both the selected reference signal 1516 and the QKD data signal 1530 in that basis to be linear and aligned if a polarization maintaining connection is used on the paths 1510, 1512, 1516 and 1530.

The switch S1 1508 must be controlled in synchronism with the input signal 1502 to properly switch the control signals to the PBS 1518 and the QKD data signal to the QKD receiver 1532. In one embodiment, the switch S1 1508 is controlled in synchronism with the input signal 1502 by using a timing signal carried on a separate optical wavelength or a separate channel.

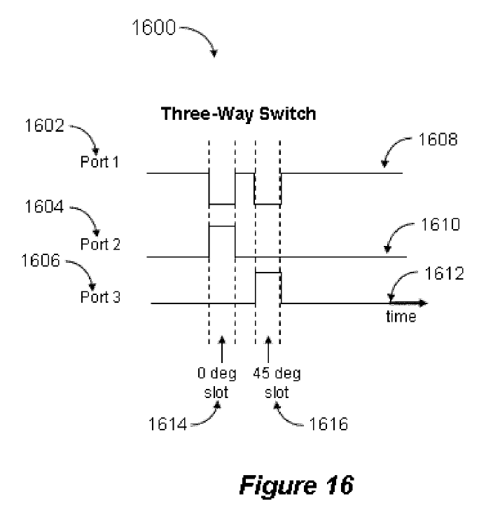

FIG. 16 is a timing diagram 1600 that illustrates the timing and transmission for the three-way optical switch S1 1508 used to separate the polarization reference signal from the QKD data signal as described in connection with FIG. 15. The timing diagram shows the timing signal 1608 at the first port 1602, the timing signal 1610 at the second port 1604, and the timing signal 1612 at the third port 1606. The 0/90° time slot 1614 and the 45/135° time slot 1616 are indicated in the diagram 1600.

Equivalents

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, which may be made therein without departing from the spirit and scope of the invention as defined by the appended claims.

What is claimed is:

1. A method of performing quantum key distribution, the method comprising: generating a QKD data signal with a polarization;
generating a polarization reference signal having a known relative polarization to the
polarization of the QKD data signal;
multiplexing the QKD data signal with the polarization reference signal;
propagating the multiplexed signal across a quantum channel;
demultiplexing the multiplexed signal propagated across the quantum channel to obtain a demultiplexed QKD data signal and a demultiplexed polarization reference signal;
transforming a polarization of the demultiplexed QKD data signal to the polarization of the generated QKD data signal in response to an intensity of the demultiplexed polarization reference signal; and
detecting the QKD data signal having the transformed polarization.

2. The method of claim 1 wherein the multiplexing the QKD data signal with the polarization reference signal comprises time multiplexing the QKD data signal with the polarization reference signal so that the QKD data signal propagates in a time slot that is different from a time slot of the polarization reference signal.

3. The method of claim 1 wherein a wavelength of the polarization reference signal is substantially the same as a wavelength of the QKD data signal.

4. The method of claim 1 wherein a wavelength of the polarization reference signal is different from a wavelength of the QKD data signal.

5. The method of claim 1 wherein a modulation format of the polarization reference signal is the same as a modulation format of the QKD data signal.

6. The method of claim 1 wherein a modulation format of the polarization reference signal is different from a modulation format of the QKD data signal.

7. The method of claim 1 wherein the polarization reference signal and the QKD data signal are generated from the same optical signal.

8. The method of claim 1 wherein the quantum channel comprises at least one of an optical fiber, a free space link, and a water link.

9. The method of claim 1 wherein the polarization reference signal and the QKD data signal experience substantially the same polarization transformation as the multiplexed signal propagates across the quantum channel.

10. The method of claim 1 wherein a polarization of the polarization reference signal and a polarization of the QKD data signal are linear and aligned.

11. The method of claim 1 wherein the transforming the polarization of the demultiplexed QKD data signal to the polarization of the generated QKD data signal comprises:
detecting an intensity of the demultiplexed polarization reference signal;
generating an electrical control signal in response to the detected intensity of the demultiplexed polarization reference signal; and
transforming the polarization of the demultiplexed QKD data signal to the polarization of the generated QKD data signal in response to the electrical control signal.

12. A quantum key distribution system (QKD) comprising: an optical transmitter comprising an optical modulator and an optical switch that generates a multiplexed QKD data and polarization reference signal at an output, wherein a relative polarization of a QKD data signal component and a polarization reference signal component of the multiplexed QKD data is known;
a quantum channel having an input that is coupled to the output of the optical transmitter, the quantum channel propagating the multiplexed QKD data and polarization reference signal; and
an optical receiver comprising an input that is coupled to the output of the quantum channel; a demultiplexer that demultiplexes the multiplexed QKD data and the polarization reference signal; a detector that detects an intensity of the demultiplexed polarization reference signal; and a polarization transformer that transforms a polarization of the demultiplexed QKD data signal in response to the detected intensity so that a polarization axis of the QKD data signal is substantially the same as a polarization axis of the QKD data signal generated by the optical transmitter.

13. The system of claim 12 wherein the optical modulator is selected from the group comprising a Mach-Zehnder interferometer, a phase modulator, and a polarization modulator.

14. The system of claim 12 wherein the optical modulator comprises a variable optical attenuator that reduces an intensity of the QKD data signal pulses to a desired level for the QKD system.

15. The system of claim 12 wherein the optical transmitter comprises an optical time delay that generates the polarization reference signal from an optical pulse stream used to generate the QKD data signal.

16. The system of claim 12 wherein the optical transmitter comprises an optical switch that generates the multiplexed QKD data signal and the polarization reference signal.

17. The system of claim 12 wherein the demultiplexer comprises an optical switch.

18. The system of claim 12 wherein the multiplexed QKD data signal and the polarization reference signal are generated from a single optical signal.

19. A dual basis quantum key distribution system (QKD) comprising:
an optical transmitter comprising: a first optical modulator that applies QKD data to an optical pulse stream with a 0/90° polarization basis; an optical switch that generates a multiplexed QKD data and polarization reference signal; and a second optical modulator that rotates a polarization of the polarization reference signal by 45°, thereby generating a dual basis multiplexed signal having pulses oriented in a 0/90° degree basis and in a 45/135° basis at an output;
a quantum channel having an input that is coupled to the output of the optical transmitter, the quantum channel propagating the dual basis multiplexed signal; and
an optical receiver comprising:
an input that is coupled to the output of the quantum channel;
a splitter that splits the dual basis multiplexed signal into a first and a second dual basis multiplexed signal;
a first optical demultiplexer that separates a first polarization reference signal and a first QKD data signal from the first dual basis multiplexed signal and a second optical demultiplexer that separates a second polarization reference signal and a second QKD data signal from the second dual basis multiplexed signal;
a first and a second detector that detect an intensity of a respective one of the first polarization reference signal and the second polarization reference signal; and
a first and a second polarization transformer that transform a respective one of the first and the second dual basis multiplexed signal in response to a respective one of the detected intensities so that a polarization axis of the first QKD data signal is oriented on the 0/90° basis and a polarization axis of a second QKD data signal is oriented on the 45/135° basis relative to the generated dual basis multiplexed signal.

20. The system of claim 19 wherein the first and the second optical modulator are chosen from the group comprising a phase modulator and a polarization modulator.

21. A dual basis quantum key distribution system (QKD) comprising:
an optical transmitter comprising: a first optical modulator that applies QKD data to an optical pulse stream with a 0/90° polarization basis; an optical switch that generates a multiplexed QKD data and polarization reference signal; and a second optical modulator that rotates a polarization of the polarization reference signal by 45°, thereby generating a dual basis multiplexed signal having pulses oriented in a 0/90° degree basis and in a 45/135° basis at an output;
a quantum channel having an input that is coupled to the output of the optical transmitter, the quantum channel propagating the dual basis multiplexed signal; and an optical receiver comprising:
a polarization controller having an input that is coupled to an output of the quantum channel;
a three-way optical switch having an input port that is coupled to an output of the polarization controller and a first output that is coupled to a QKD receiver, the three-way switch directing the QKD data signal to the QKD receiver and directing a first and second portion of the polarization reference signal to a respective one of a second output port and a third output port;
a two-way switch having a first input port and second input port that are coupled to a respective one of the second output port and third output port of the three-way optical switch, the two-way switch directing a selected one of the 0/90° polarization reference signal and the 45/135° polarization reference signal to an output port;
an optical detector that detects the selected one of the 0/90° polarization reference signal and the 45/135° polarization reference signal, the optical detector generating an electrical control signal in response to an intensity of the selected one of the 0/90° polarization reference signal and 45/135° polarization reference signal; and
a processor having an input that receives the electrical signal generated by the optical detector and an output that is electrically connected to a electrical input of the polarization controller, the processor generating a polarization control signal at the output that causes the polarization controller to transform a polarization of the dual basis multiplexed signal to a known orientation relative to the generated dual basis multiplexed signal.

22. The system of claim 20 wherein the three-way optical switch comprises at least two two-way optical switches.
